(19) United States
(12) Patent Application Publication
(10) Pub. No.: US 2012/0064390 A1
(43) Pub. Date: Mar. 15, 2012

(54) LITHIUM ION BATTERY ELECTROLYTE AND LITHIUM BATTERY HAVING THE SAME

(75) Inventors: Huiying Wang, Shenzhen (CN); Guishu Zhou, Shenzhen (CN)

(73) Assignee: BYD Company Limited

(21) Appl. No.: 13/229,412

(22) Filed: Sep. 9, 2011

(30) Foreign Application Priority Data
Sep. 13, 2010 (CN) 201010279113.1

(51) Int. Cl. H01M 10/056; H01M 2/02

(52) U.S. Cl. 429/163; 429/329; 429/331; 429/332; 429/334

(57) ABSTRACT

Electrolytes of lithium ion batteries of the present disclosure comprise: a lithium salt, a non-aqueous solvent, and an additive. The additive further comprises a first and second compound. The first compound is a 4 X1, 5 R1 [1,3]dioxolan-2-one, wherein X1 is selected from the group consisting of: F, Cl, and Br and R1 is selected from the group consisting of hydrogen and linear alkyl compounds having between 1 and 3 carbon atoms. The second compound has a molecular formula of: F(CF₂CF₂)ₓ—CH₂CH₂—(CH₂CH₂O)_{y}H, wherein x is any integer ranging from 1 to 7, and y is any integer ranging from 1 to 15.

### CROSS-REFERENCE TO RELATED APPLICATION

This application claims priority to and the benefit of Chinese Patent Application No. 201010279113.1, which was filed with the State Intellectual Property Office, P. R. C. on Sep. 13, 2010, and the content of which is incorporated herein by reference in its entirety.

### FILED

The present disclosure relates generally to lithium ion batteries. More particularly, the present disclosure relates to lithium ion battery electrolytes and lithium ion batteries having the electrolytes.

### BACKGROUND

Prior lithium batteries used in cell phones, walkmans, PDAs, notebook computers, and other electronic products are generally known.

The discharge rate of a lithium ion battery is the rate at which Li ions move or diffuse from the surface of the negative electrode, through the electrolyte, into the positive electrode. Generally speaking, the higher the discharge rate the higher the power of the lithium ion battery.

Without wishing to be bound by the theories, Applicant believes that prior methods of increasing the discharge rate may include: decreasing the compacted density of the positive and negative material, which may enable the electrolyte to distribute uniformly between the positive electrode and negative electrode; decreasing the viscosity of the electrolyte; adding a film forming additive to form a thin and compact solid electrolyte interface (“SEI”) film on the negative electrode, which may enhance the penetrating ability of Li⁺.

### SUMMARY

In accordance with various illustrative embodiments hereinafter disclosed lithium ion battery electrolytes, which may comprise: a lithium salt, a non-aqueous solvent, and an additive. The additive may comprise a first compound having a first structure of:

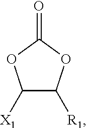

wherein X₁ may be selected from the group consisting of: F, Cl and Br and R₁ may be selected from the group consisting of hydrogen and linear alkyl compounds having between 1 and 3 carbon atoms. The additive may additional comprise a second compound having a molecular formula of: F(CF₂CF₂)ₓ—CH₂CH₂—(CH₂CH₂O)_{y}H, wherein x is any integer ranging from 1 to 7, and y is any integer ranging from 1 to 15.

In accordance with various alternative illustrative embodiments hereinafter disclosed are lithium ion batteries comprising: a battery shell; an electrical core disposed in the shell, wherein the electrical core comprises a positive electrode and a negative electrode having a septum therebetween; a non-aqueous solvent, a lithium salt, and an additive. The additive may comprise a first compound having a first structure of:

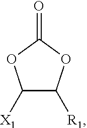

wherein X₁ may be selected from the group consisting of: F, Cl and Br and R₁ may be selected from the group consisting of hydrogen and linear alkyl compounds having between 1 and 3 carbon atoms. The additive may additional comprise a second compound having a molecular formula of: F(CF₂CF₂)ₓ—CH₂CH₂—(CH₂CH₂O)_{y}H, wherein x is any integer ranging from 1 to 7, and y is any integer ranging from 1 to 15.

Without wishing to be bound by the theory, Applicants believe that the electrolyte and batteries according to the present disclosure may exhibit enhanced electrical conductive ability of Li⁺ and increased diffusion rate of Li⁺. Further without wishing to be bound by the theory, Applicants believe that the good/relatively high diffusion ability and rate of Li⁺ in the electrolyte may result in good high rate discharge ability and good low temperature performance even under the condition of high energy density and while ensuring a stable cycle performance.

While lithium ion battery electrolytes, and lithium-ion batteries thereof, will be described in connection with various preferred illustrative embodiments, it will be understood that this disclosure is not intended to limit the lithium ion battery electrolytes, and lithium-ion batteries thereof to those embodiments. On the contrary, this disclosure is intended to cover all alternatives, modifications, and equivalents as may be included within the spirit and scope of the lithium ion battery electrolytes, and lithium-ion batteries thereof as defined by the appended claims. Further, in the interest of brevity, clarification, and without limitation, the numerical ranges provided herein are intended to be inclusive of all alternative ranges. As a non-limiting example, where a weight percent ranging from “about 0.1 to about 9 weight percent” is provided, it is intended to disclose all intermediate ratios, including without limitation from about 0.1 to about 8.9, from about 0.2 to about 8.8, etc.

### DETAILED DESCRIPTION

Reference will be made in detail to embodiments of the present disclosure. The embodiments described herein are explanatory and illustrative, which are used to generally understand the present disclosure. The embodiments shall not be construed to limit the present disclosure.

In an embodiment, lithium ion battery electrolytes are disclosed herein, which may comprise: a lithium salt, a non-aqueous solvent, and an additive. The additive may comprise a first compound having a first structure of:

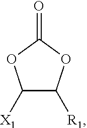

wherein X₁ may be selected from the group consisting of: F, Cl and Br and R₁ may be selected from the group consisting of hydrogen and linear alkyl compounds having between 1 and 3 carbon atoms. Accordingly in various embodiments, R₁ may be selected from the group consisting of: H, —CH₃ or —C2H5. In still further embodiments, the first compound may be selected from the group which consisting of fluoro-ethylene carbonate (F-EC), chlor-ethylene carbonate to (Cl-EC), fluoro-propylene carbonate (F-PC), chlor-propylene carbonate (Cl-PC). In still further embodiments, the additive may comprising a first compound having a molecular formula of: 4 X1, 5 R1 [1,3]dioxolan-2-one, wherein X₁ may be selected from the group consisting of: F, Cl and Br and R₁ may be selected from the group consisting of hydrogen and linear alkyl compounds having between 1 and 3 carbon atoms.

The additive may additional comprise a second compound having a molecular formula of F(CF₂CF₂)ₙ—CH₂CH₂—(CH₂CH₂O)_{y}H, wherein x is any integer ranging from 1 to 7, and y is any integer ranging from 1 to 15. Alternatively, x may be any integer ranging from 2 to 5 and y may be any integer ranging from 1 to 5. In an embodiment, the second compound may be FSO (F(CF₂CF₂)₃—CH₂CH₂—(CH₂CH₂O)_{y} H, wherein y may be any integer ranging from 1 to 5.

In an embodiment, the lithium ion battery electrolyte may include a relatively minor amount of the additive. In an embodiment, the lithium ion battery electrolyte may include from about 0.1 to about 9 wt % additive, based on the total weight of the electrolyte. Alternatively, the lithium ion battery electrolyte may include from about 0.1 to about 8 wt % of the first compound of the additive and from about 0.01 to about 1 wt % of the second compound of the additive, based on the total weight of the electrolyte.

The lithium salts suitable for use in the present disclosure may include those generally known by those of ordinary skill in the art. Without limitation, the lithium salt may be at least one material selected from the group consisting of: LiClO₄, LiPF₆, LiBF₄, LiAsF₆ and one or several of the Li(CF₃CO₂)₂N, LiCF₃SO₃, Li(CF₃SO₂)₃, Li(CF₃SO₂)₂N. In an embodiment, the concentration of the lithium salt may be range from about 0.5 to about 1.5 moles per liter (“mol/L”) and alternatively from about 0.8 to about 1.3 mol/L.

The non-aqueous solvents suitable for use in the present disclosure may include those generally known by those of ordinary skill in the art. In an embodiment, the viscosity of the non-aqueous solvent may be optimized to enhance both the diffusion rate of Li⁺ and the cycle performance of the battery. In an embodiment, the non-aqueous solvent may be a mixture of a first solvent and a second solvent. The first solvent may be at least one of the ethylene carbonate (EC) and propylene carbonate (PC). The second solvent may be at least one of dimethyl carbonate (DMC), ethyl methyl carbonate (EMC), diethyl carbonate (DEC), methyl acetate, 1,2-dimethoxy ethane, butylene carbonate, 2-methyltetrahydrofuran, 1,2-Butylene carbonate, methyl propionate, methyl formate and tetrahydrofuran. Optionally, the first solvent may be a mixture of ethylene carbonate (EC) and propylene carbonate (PC), and the second solvent may be a mixture of dimethyl carbonate (DMC), ethyl methyl carbonate (EMC) and diethyl carbonate (DEC). In an embodiment, the viscosity of the first solvent may be higher than the viscosity of the second solvent.

Based on 100 parts of volume of the non-aqueous solvent, the shares of the first solvent may range from about 15 to about 40, and the shares of the second solvent may range from about 60 to about 85. In an embodiment, based on 100 parts of volume of the second solvent, the shares of the dimethyl carbonate (DMC), ethyl methyl carbonate (EMC) may range from about 50 to about 80, and the shares of the diethyl carbonate (DEC) may range from about 5 to about 35.

The amount, and weight percent, of lithium salt and non-aqueous solvent need not be limited to any particular range and may generally vary. In alternative embodiments, the lithium ion battery electrolyte may include from about 10 to about 20 weight percent lithium salt, based on the total weight percent of the electrolyte. In alternative embodiments, the lithium ion battery electrolyte may include from about 75 to about 88 weight percent non-aqueous solvent, based on the total weight percent of the electrolyte.

According to the present disclosure, a lithium ion battery may be provided. The lithium ion battery may comprise a battery shell; an electrical core disposed in the shell and an electrolyte. The electrical core may include a positive electrode and a negative electrode having a septum therebetween. The electrolyte may be the lithium ion battery electrolyte as disclosed generally herein.

In an embodiment, the first compound may be a halogenated carbonate. Without wishing to be bound by the theory, Applicant believes that the halogenated carbonate may beneficially form the SEI film and increase the electrical conductive performance of Li⁺ within the battery. In an embodiment, the second compound may be an ethoxyl non-ionic perfluorocarbon surfactant. Without wishing to be bound by the theory, Applicant believes that the second compound may reduce the surface tension of the electrolyte and thus improve the humidity and leveling property of the electrode plate surface. Applicant further believes—without wishing to be bound by the theory—that improving the humidity and leveling property of the electrode plate surface may increase the salvation, solvent removal ability, and the diffusion rate of the Li⁺. Thus, in an embodiment, Applicant believes without limitation that the presently disclosed lithium ion batteries may have good cycle performance and high temperature properties because of formation of an SEI film. Further, Applicant believes without limitation that the lithium ion batteries according to the present disclosure may have excellence high rate discharge ability while maintain good low temperature properties.

Methods for preparing the positive electrode, negative electrode, the septum, as well as the assembly of the lithium ion battery may be generally known to those of ordinary skill in the art.

The following examples may further describe, without limitation, electrolytes and batteries of the present disclosure.

### Example 1

The lithium ion battery A1 was obtained as follows:

### Step 1: Preparing the Electrolyte

About 15 wt % of LiPF₆, 0.5 wt % of fluoro-ethylene carbonate (F-EC), 0.05 wt % of FSO(F(CF₂CF₂)₃—CH₂CH₂—(CH₂CH₂O)₃H and about 84.45 wt % of the non-aqueous solvent were mixed uniformly to obtain the electrolyte of Example 1 hereinafter referred to as “S1” The volume ratio of the components of the non-aqueous solvent were EC: EMC: DMC=3:5:2.

### Step 2: Preparing the Positive Electrode Plate

A conductive agent (LiCoO₂) and an adhesive were mixed uniformly according to the weight ratio of about 92:4:4. Then the solvent was added to obtain a positive electrode slurry. Next, the positive electrode slurry was coated on the aluminum plate. The coated aluminum plate was rolled after drying to obtain the positive electrode plate.

### Step 3: Preparing the Negative Electrode Plate

Carbon, conductive agent, and adhesive were mixed uniformly according to the weight ratio of 95:2:3. Then the solvent was added to obtain a negative electrode slurry. The negative electrode slurry was coated on the aluminum plate. The coated aluminum plate was rolled after drying to obtain the negative electrode plate.

### Step 4: Assembly of the Lithium Ion Battery

The positive electrode plate obtained in step 2 above, the negative electrode plate obtained in step 3 above, and polyethylene (PE) were stacked and rolled in turn to form an electrode core. The electrode core was set in a shell, and the electrolyte S1 was added. Then the shell was sealed to form the lithium ion battery of Example 1 (“A1”). The content of the battery A1 was designed with about 2400 Mah, and the bulk energy density was about 520 wh/L. According to Example 1, the electrical core was housed in a cylindrical shell 1865, the electrolyte S1 was added into the shell, and then the shell was sealed to form the lithium ion battery A1. The lithium ion battery A1 had a designed capacity of about 2400 mAh and a volumetric energy density of about 520 wh/L.

### Example 2

The lithium ion battery of Example 2 (“A2”) was made in the same manner as described in Example 1, except that: the FSO was F(CF₂CF₂)₃—CH₂CH₂—(CH₂CH₂O)₅H (x=3, y=5); and the first compound of the additive was fluoro-propylene carbonate (F-PC).

The weight ratio of the LiPF₆, fluoro-propylene carbonate (F-PC), FSO (x=3, y=5), and the non-aqueous solvent was about 15:0.2:0.5:84.3. The electrolyte obtained is hereinafter referred to as “S2.”

### Example 3

The lithium ion battery of Example 3 (“A3”) was made in the same manner as described in Example 1, except that: the FSO was F(CF₂CF₂)₂—CH₂CH₂—(CH₂CH₂O)₂H (x=2, y=2); and the first compound of the additive was chlor-ethylene carbonate (Cl-EC).

The weight ratio of the LiPF₆, chlor-ethylene carbonate (Cl-EC), FSO (x=2, y=2), and the non-aqueous solvent was about 15:1:0.1:83.9. The electrolyte obtained is hereinafter referred to as “S3”.

### Example 4

The lithium ion battery of Example 4 (“A4”) was made in the same manner as described in Example 1, except that: the FSO was F(CF₂CF₂)₅—CH₂CH₂—(CH₂CH₂O)₅H (x=5, y=5); and the first compound of the additive was chlor-propylene carbonate (Cl-PC).

The weight ratio of the LiPF₆, chlor-propylene carbonate (Cl-PC), FSO (x=5, y=5), and the non-aqueous solvent was about 15:3:0.2:81.8. The electrolyte obtained is hereinafter referred to as “S4.”

### Example 5

The lithium ion battery of Example 5 (“A5”) was made in the same manner as described in Example 1, except that: the FSO was F(CF₂CF₂)₇—CH₂CH₂—(CH₂CH₂O)₁₀H (x=7, y=10); and the first compound of the additive was fluoro-propylene carbonate (F-PC).

The weight ratio of the LiPF₆, chlor-propylene carbonate (Cl-PC), FSO (x=7, y=10), and the non-aqueous solvent was about 15:5:0.8:79.2. The electrolyte obtained is hereinafter referred to as “S5.”

### Example 6

The lithium ion battery of Example 6 (“A6”) was made in the same manner as described in Example 1, except that: the FSO was F(CF₂CF₂)₃—CH₂CH₂—(CH₂CH₂O)₃H (x=3, y=3); and the first compound of the additive was fluoro-ethylene carbonate (F-EC).

The weight ratio of the LiPF₆, fluoro-ethylene carbonate (F-EC), FSO (x=3, y=3), and the non-aqueous solvent was about 15:8:1:76. The electrolyte obtained is hereinafter referred to as “S6.”

### Comparative Example 1

The lithium ion battery of Comparative Example 1 (“DA1”) was made in the same manner as described in Example 1, except that:

Fluoro-ethylene carbonate (F-EC) was not added into the electrolyte of the lithium ion battery C1 in the step 1. The electrolyte obtained is hereinafter referred to as “DA1.”

### Comparative Example 2

The lithium ion battery of Comparative Example 2 (“DA2”) was made in the same manner as described in Example 1, except that:

FSO (of which x=3, y=3) was not added into the electrolyte of the lithium ion battery C2 in the step 1. The electrolyte obtained is hereinafter referred to as “DA2.”

Performance Test:

The secondary battery performance test equipment BS-9300 (R) was adopted to test the cycle performance, rate power and low temperature discharge ability of the lithium ion batteries A1 to A6 and DA1 and DA2.

1. Cycle Performance Test:

The lithium ion battery was set in the test condition with a temperature of about 23±2 C to conduct the 1 C (2400 mA) charge and discharge cycle and then record the content surplus rate. The charge manner was charged to 4.2V with a stable current of about 1 C (2400 mA). The discharge manner was discharge until 3.0V with a stable current. The test results are provided in Table 1 below. The i times content surplus rate=the discharge content of the i times cycle/the first discharge content×100%.

TABLE 1

| | Content Surplus Rate (%) | | | | | | | |
|---|---|---|---|---|---|---|---|---|
| Cycle Times | A1 | A2 | A3 | A4 | A5 | A6 | DA1 | DA2 |
| 10 | 98.8 | 98.5 | 99.1 | 99.3 | 98.5 | 99.2 | 97.6 | 97.7 |
| 30 | 96.8 | 96.9 | 97.5 | 97.3 | 96.6 | 97.4 | 95.4 | 95.3 |
| 70 | 94.5 | 95.1 | 95.7 | 95.3 | 94.1 | 95.5 | 91.8 | 90.3 |
| 100 | 92.8 | 93.7 | 94.0 | 93.2 | 92.4 | 93.8 | 89.1 | 87.8 |
| 150 | 91.1 | 91.7 | 92.3 | 91.6 | 90.4 | 92.0 | 86.0 | 83.2 |
| 200 | 89.4 | 90.1 | 90.6 | 89.7 | 88.6 | 90.7 | 82.5 | 78.5 |
| 250 | 87.2 | 88.2 | 88.9 | 87.9 | 86.5 | 89.1 | 79.4 | 73.4 |
| 300 | 85.3 | 86 | 86.7 | 85.6 | 84.2 | 87.3 | 76.9 | End |
| 350 | 83.2 | 84 | 84.7 | 83.6 | 82.1 | 85.2 | 74.1 | |
| 400 | 81.2 | 82.5 | 83.5 | 82.0 | 79.9 | 83.9 | End | |
| 450 | 79.6 | 81.9 | 82.7 | 81.1 | 78.1 | 83.1 | | |

2. Rate Power and Low Temperature Discharge Test

The lithium ion battery was charged to 4.2V with a stable current of about 0.5 C (1200 mAh) under the temperature of about 23±2 C. The end current was about 130 mA. Respectively depositing the charged lithium ion battery under the temperature (of about 23 C, −10 C, −20 C) for about 12 hours to discharge according to different rate power of 0.5 C, 3 C, 5 C. Based on the discharge content with a current of 0.5 C under the temperature of about 23 C (100%), the discharge rate was obtained by analysis of the ratio between the discharge content and the basic discharge content in different conditions. The results are results are provided in Table 2 below. Specifically, 1 C=2400 mA, 3 C=7200 mA, 0.5 C=1200 mA.

TABLE 2

| | Temperature | | | | | | | | |
|---|---|---|---|---|---|---|---|---|---|
| | Discharge rate | | | Discharge rate | | | Discharge rate | | |
| | under 23 C. | | | under −10 C. | | | under −20 C. | | |
| Rate power | 0.5 C | 3 C | 5 C | 0.5 C | 3 C | 5 C | 0.5 C | 3 C | 5 C |
| A1 | 100 | 86 | 73 | 88 | 48 | 24 | 71 | 33 | 15 |
| A2 | 100 | 85 | 75 | 89 | 50 | 23 | 79 | 35 | 14 |
| A3 | 100 | 90 | 78 | 87 | 55 | 26 | 80 | 36 | 15 |
| A4 | 100 | 91 | 82 | 91 | 64 | 28 | 74 | 41 | 18 |
| A5 | 100 | 86 | 72 | 90 | 60 | 26 | 73 | 38 | 15 |
| A6 | 100 | 86 | 73 | 87 | 45 | 20 | 70 | 31 | 12 |
| DA1 | 100 | 77 | 38 | 75 | 23 | 3 | 39 | 12 | 2 |
| DA2 | 100 | 66 | 36 | 65 | 19 | 3 | 35 | 15 | 1 |

Applicant believes without wishing to be bound by the theory that Table 1 illustrates that, as compared to DA1 and DA2, the lithium ion batteries A1 to A6 have better cycle performance, even cycled for about 450 times, and higher content surplus rates.

Applicant believes without wishing to be bound by the theory that Table 2 illustrates that when under 23 C, the batteries A1 to A6, DA1 and DA2 had about the same rate discharge performance when discharged with a current of about 0.5 C; however, when the discharge rate was changed to 5 C, compared with DA1 and DA2, the discharge rates of the lithium ion batteries A1 to A6 were higher. Further, without wishing to be bound the illustration, Applicant believes that Table 2 illustrates that when discharged with current of 0.5 C to 3 C under a temperature of about −10 C, the battery energy density increased, and the lithium ion batteries A1 to A6 had better rate discharge performance, as compared with DA1, DA2. Further without limitation, Applicant believes that when the temperature was dropped to about −20 C, the electrolyte of the DA1 and DA2 may be too viscid to discharge, contrastively, the lithium ion batteries A1 to A6 had good lowness rate discharge and high rate discharge performance under temperatures of about −20 C.

What is claimed is:

1. A lithium ion battery electrolyte comprising: a lithium salt, a non-aqueous solvent, and an additive,
wherein the additive comprises:
a first compound having a first structure of 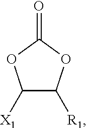
wherein X₁ is selected from the group consisting of: F, Cl and Br and R₁ is selected from the group consisting of hydrogen and linear alkyl compounds having between 1 and 3 carbon atoms; and
a second compound having a molecular formula of: F(CF₂CF₂)ₓ—CH₂CH₂—(CH₂CH₂O)_{y}H, wherein x is any integer ranging from 1 to 7, and y is any integer ranging from 1 to 15.

2. The lithium ion battery electrolyte of claim 1, wherein the first compound is selected from the group consisting of: fluoro ethylene carbonate, chlorine ethylene carbonate, fluoroacrylate, and chlorine acrylate.

3. The lithium ion battery electrolyte of claim 1, wherein x is any integer ranging from 2 to 5, and y is any integer ranging from 1 to 5.

4. The lithium ion battery electrolyte of claim 1 having from about 0.1 to about 9 weight percent additive, based on the total weight of the lithium ion battery electrolyte.

5. The lithium ion battery electrolyte of claim 1 having from about 0.1 to about 8 weight percent first compound and from about 0.01 to about 1 weight percent second compound.

6. The lithium ion battery electrolyte of claim 1 having from about 10 to about 20 weight percent lithium salt and from about 75 to about 88 weight percent non-aqueous solvent.

7. The lithium ion battery electrolyte of claim 1, wherein the lithium salt is selected from the group consisting of LiClO₄, LiPF₆, LiBF₄, LiAsF₆, Li(CF₃CO₂)₂N, LiCF₃SO₃, Li(CF₃SO₂)₃, Li(CF₃SO₂)₂N.

8. The lithium ion battery electrolyte of claim 1, wherein the non-aqueous solvent has a first solvent and a second solvent, the first solvent is selected from the group consisting of: ethene carbonate, propylene carbonate, and combinations thereof; and the second solvent is selected from the group consisting of: dimethyl carbonate, ethyl methyl carbonate, diethyl carbonate, methyl acetate, 1,2-dimethoxy ethane, butylene carbonate, 2-methyltetrahydrofuran, 1,2-Butylene carbonate, methyl to propionate, methyl formate, tetrahydrofuran, and combinations thereof.

9. The lithium ion battery electrolyte of claim 1, wherein the first solvent is a combination of ethene carbonate and propylene carbonate, the second solvent is a combination of: dimethyl carbonate, ethyl methyl carbonate, and diethyl carbonate; and wherein based on 100 parts by volume of the non-aqueous solvent, the first solvent ranges from about 15 to about 40 percent of the total volume, and the second solvent ranges from about 60 to about 85 percent of the total volume.

10. A lithium ion battery comprising: a shell; an electrical core disposed in the shell, wherein the electrical core comprises a positive electrode and a negative electrode having a septum therebetween; a non-aqueous solvent, a lithium salt, and an additive,
wherein the additive comprises:
a first compound having a first structure of 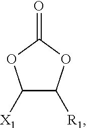
wherein X₁ is selected from the group consisting of: F, Cl and Br and R₁ is selected from the group consisting of hydrogen and linear alkyl compounds having between 1 and 3 carbon atoms; and
a second compound having a molecular formula of: F(CF₂CF₂)ₓ—CH₂CH₂—(CH₂CH₂O)_{y}H, wherein x is any integer ranging from 1 to 7, and y is any integer ranging from 1 to 15.

11. The lithium ion battery of claim 10, wherein the first compound is selected from the group consisting of: fluoro ethylene carbonate, chlorine ethylene carbonate, fluoroacrylate, and chlorine acrylate.

12. The lithium ion battery of claim 10, wherein x is any integer ranging from 3 to 7, and y is any integer ranging from 1 to 5.

13. The lithium ion battery of claim 10 having from about 0.1 to about 9 weight percent additive, based on the total weight of the lithium ion battery electrolyte.

14. The lithium ion battery of claim 10 having from about 0.1 to about 8 weight percent first compound and from about 0.01 to about 1 weight percent second compound.

15. The lithium ion battery of claim 10 having from about 10 to about 20 weight percent lithium salt and from about 75 to about 88 weight percent non-aqueous solvent.

16. The lithium ion battery of claim 10, wherein the lithium salt is selected from the group consisting of: LiClO₄, LiPF₆, LiBF₄, LiAsF₆, Li(CF₃CO₂)₂N, LiCF₃SO₃, Li(CF₃SO₂)₃, Li(CF₃SO₂)₂N.

17. The lithium ion battery of claim 10, wherein the non-aqueous solvent has a first solvent and a second solvent, the first solvent is selected from the group consisting of: ethene carbonate, propylene carbonate, and combinations thereof; and the second solvent is selected from the group consisting of: dimethyl carbonate, ethyl methyl carbonate, diethyl carbonate, methyl acetate, 1,2-dimethoxy ethane, butylene carbonate, 2-methyltetrahydrofuran, 1,2-Butylene carbonate, methyl propionate, methyl formate, tetrahydrofuran, and combinations thereof.

18. The lithium ion battery of claim 10, wherein the first solvent is a combination of ethene carbonate and propylene carbonate, the second solvent is a combination of: dimethyl carbonate, ethyl methyl carbonate, and diethyl carbonate; and wherein based on 100 parts by volume of the non-aqueous solvent, the first solvent ranges from about 15 to about 40 percent of the total volume, and the second solvent ranges from about 60 to about 85 percent of the total volume.
